(19) United States
(12) Patent Application Publication
(10) Pub. No.: US 2011/0306709 A1
(43) Pub. Date: Dec. 15, 2011

(54) COLOR-FADING PRIMER COMPOSITION

(76) Inventors: Tomoyuki Torii, Osaka (JP); Kiyoshi Nakayama, Osaka (JP); Yoshimitsu Nakayama, Osaka (JP); Takehiko Nakamura, Osaka (JP); Masaaki Murase, Osaka (JP)

(21) Appl. No.: 13/202,652

(22) PCT Filed: Feb. 22, 2010
(86) PCT No.: PCT/JP2010/052612

§ 371 Date: Aug. 22, 2011

(30) Foreign Application Priority Data
Feb. 23, 2009 (JP) 2009-039056

(51) Int. Cl. C08K 5/3417; C09D 133/00; C09D 175/00

(52) U.S. Cl. 524/94; 524/589; 524/556

(57) ABSTRACT

The present invention provides a primer composition for sealant in which the coating quality can be visually inspected and which can sufficiently fade on exposure to the light. The primer composition for sealant use comprises (A) a binder resin and (B) one type or two or more types of pigment selected from the group composed of curcumin pigment, monascus pigment, chlorophyll, paprika pigment, marigold pigment and caramel pigment.

### FIELD OF THE INVENTION

The present application claims the Paris Convention priority based on Japanese Patent Application No. 2009-039056 filed on Feb. 23, 2009, the entire content of which is incorporated herein by reference.

The present invention relates to a primer composition for a sealant. In more particular, the present invention relates to a colored primer composition which can fade on exposure to the light.

### BACKGROUND ART

In an application of a sealant for construction, a step of coating a primer is essentially required. However, the difficulty of the visual inspection of the coating quality varies depending on the characteristic of a primer or the kind of adherend (a porous member such as siding board). As a result, the holiday or the unevenness in a coating occurs. The coating defect of a primer leads to a detachment of a sealant.

A primer is colored with a pigment so as to visually inspect the coating quality of a primer. However, a problem occurs in the appearance when the colored primer overflows or adheres to the adherend surface (the external wall surface).

An aqueous photofading primer in which a specific edible synthetic pigment such as Food Blue No. 1 is blended with a primer is proposed (see, Patent Document 1). However, the above-mentioned aqueous photofading primer is limited in the use for a solvent-based primer because of the solubility or the fading property of a pigment used. In addition, an aqueous primer has many problems in which the aqueous primer freezes at low temperature and the working efficiency decreases at a construction site. Further, the above-mentioned pigment is not necessarily satisfactory in the fading property.
Patent Document 1: JP-A-2002-285098

### SUMMARY OF THE INVENTION

An object of the present invention is to provide a primer composition, in particular, a solvent-based primer composition, for a sealant, in which the coating quality can be visually inspected and which can sufficiently fade on exposure to the light.

The present inventors have made painstaking studies in order to solve the above-mentioned object. As a result, they have found that the object can be achieved by a primer composition for a sealant which contains a specific pigment as a color-fading pigment, and thus the present invention has been completed.

The present invention is intended to provide the following embodiments.

[1] A primer composition for sealant, comprising
(A) a binder resin, and
(B) one or more pigments selected from the group consisting of curcumin pigment, monascus pigment, chlorophyll, capsicum pigment, marigold pigment and caramel pigment.
[2] The primer composition according to the above-mentioned [1], comprising 0.001 to 10 wt. %, based on the whole amount of the composition, of the pigment (B).
[3] The primer composition according to the above-mentioned [1] or [2], wherein the pigment (B) comprises curcumin pigment.
[4] The primer composition according to the above-mentioned [1] or [2], wherein the pigment (B) comprises monascus pigment.
[5] The primer composition according to the above-mentioned [1] or [2], wherein the pigment (B) comprises chlorophyll.
[6] The primer composition according to any one of the above-mentioned [1]-[5], wherein the binder resin (A) comprises a yellowing-resistant resin.
[7] The primer composition according to the above-mentioned [6], wherein the yellowing-resistant resin is selected from the group consisting of an aliphatic polyisocyanate, an aliphatic urethane resin, a cycloaliphatic polyisocyanate, a cycloaliphatic urethane resin, an olefin resin, an acrylate resin, a polyester resin and a silicone resin.

### EFFECTS OF THE INVENTION

A primer composition of the present invention is colored with a specific fading pigment. Accordingly, the coating quality can be visually inspected and the primer composition can sufficiently fade on exposure to the light after coating. Therefore, according to the primer composition of the present invention, a problem caused by the holiday or the unevenness in a coating and a problem of the appearance caused by overflow and adherence of a primer can be prevented.

In particular, the primer composition according to the present invention is a solvent system, and thus, can be used even in the working environment or the use in which an aqueous primer composition is hardly applied.

### EMBODIMENTS OF THE INVENTION

Examples of the binder resin (A) in the primer composition of the present invention include a polyisocyanate, a urethane resin, an acrylate resin, an olefin resin, a polyester resin, an epoxy resin, a silicone resin and the like.

These binder resins can be used alone or can also be used in combination with other binder resins.

The amount of the binder resin in the primer composition of the present invention is, but not limited to, preferably 0.5 to 50 wt. %, more preferably 5 to 50 wt. %, particularly preferably 10 to 45 wt. % based on the whole amount of the composition from the viewpoint of the workability and the adhesiveness. When the binder resin is used in an amount of less than 0.5 wt. %, the adhesiveness, in particular, in a porous adherend, is decreased. When the binder resin is used in an amount of more than 50 wt. %, the workability significantly diminishes and a mottle occurs in a coating.

The above-mentioned polyisocyanates are not particularly limited. Examples of the above-mentioned polyisocyanates include the conventionally known various polyisocyanates such as aromatic polyisocyanate, cycloaliphatic polyisocyanate and aliphatic polyisocyanate as well as urethane-, allophanate-, uretdione-, isocyanurate-, carbodiimide-, uretimine-, urea-, biuret-modified products thereof.

In the present invention, one kind or two or more kinds thereof may be used.

The above-mentioned urethane resins are not particularly limited. Examples of the urethane resins include the conventionally known various urethane resins such as compound comprising the above-mentioned polyisocyanate compound and a polyol. Examples of the polyols include conventionally known various polyols such as polyether polyols obtained by addition polymerization of a propylene oxide or a propylene oxide and an alkylene oxide such as ethyleneoxide to polyhydric alcohol such as ethylene glycol, propylene glycol, glycerin, trimethylolpropane, pentaerythritol, sorbitol and sucrose; ethylene glycol, propylene glycol and oligo glycols thereof; butylene glycol, hexylene glycol, polytetramethylene ether glycols; polycaprolactone polyols; polycarbonate polyols; polyester polyols such as polyethylene adipate; polybutadiene polyols; higher fatty acid esters having a hydroxyl group such as castor oil; polymeric polyols in which vinyl monomers are graftized to polyether polyols or polyester polyols.

In the present invention, one kind or two or more kinds thereof may be used.

The above-mentioned acrylic resins are not particularly limited. Examples of the above-mentioned acrylic resins include the conventionally known various acrylic resins such as alkyl (meta)acrylate such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, neopentyl (meth)acrylate, 2-ethylhexyl (meth)acrylate, isodecyl (meth)acrylate, lauryl (meth)acrylate, tridecyl (meta)acrylate and stearyl (meta)acrylate; multivalent acrylic ester such as trimethylolpropane tri(meta)acrylic ester; alicyclic alkyl (meta)acrylate such as cyclohexyl (meta)acrylate, isobornyl (meta)acrylate, tricyclo decinyl (meta)acrylate and tetrahydrofurfuryl (meta)acrylate; (meta)acrylic ester containing hetero atoms such as 2-methoxy ethyl (meta)acrylate, dimethylaminoethyl (meta)acrylate, chloroethyl (meta)acrylate and trifluoroethyl (meta)acrylate as well as polymers or copolymers thereof. In addition, a copolymer of the above-mentioned acrylic monomer and a copolymerizable monomer such as vinyl acetate and styrene may also be mentioned.

In the present invention, one kind or two or more kinds thereof may be used.

The above-mentioned olefine resins are not particularly limited. Examples of the above-mentioned olefine resins include the conventionally known various olefine resins such as isobutylene, isobutylene-based polymer containing a silyl group, polyethylene, polypropylene, polybutene, polymer of alpha-olefin, ethylene-propylene copolymer, propylene-butene copolymer, ethylene-propylene-butene terpolymer.

In the present invention, one kind or two or more kinds thereof may be used.

The above-mentioned polyester resins are not particularly limited. Examples of the above-mentioned polyester resins include the conventionally known various polyester resins such as polyester obtained by reacting a dicarboxylic acid component such as terephthalic acid, isophthalic acid, 2,6-naphthalene dicarboxylic acid, Hexahydro terephthalic acid, 4,4′-diphenyldicarboxylic acid, adipic acid, sebacic acid, dodecane dicarboxylic acid, 5-Na sulfoisophthalic acid, 5-K sulfoisophthalic acid and a glycol component such as ethylene glycol, diethylene glycol, propylene glycol, 1,3-propanediol, 1,4-butanediol, cyclohexane dimethanol, polyethylene glycol, bisphenol A/alkylene oxide adduct.

In the present invention, one kind or two or more kinds thereof may be used.

The above-mentioned epoxy resins are not particularly limited. Examples of the above-mentioned epoxy resins include the conventionally known various epoxy resins such as glycidyl ether epoxy resin, glycidyl ester epoxy resin, glycidyl amine epoxy resin, linear aliphatic epoxide epoxy resin, alicyclic epoxide epoxy resin; and the modified products thereof such as rubber-modified epoxy resin [a reaction product of a bisphenol epoxy resin (a diglycidyl ether of bisphenol A, bisphenol F or bisphenol AD, a diglycidyl ether of alkylene oxide addition product of bisphenol A, and the like) with a butadiene-acrylonitrile-(meth)acrylic acid copolymer], urethane-modified epoxy resin [a reaction product of a urethane prepolymer containing a terminal NCO obtained by reacting a polytetramethylene ether glycol (molecular weight: from 500 to 5000) with an excess amount of a diisocyanate (tolylene diisocyanate, diphenylmethane diisocyanate, and the like) with an OH-containing epoxy resin (a diglycidyl ether of bisphenol A, a diglycidyl ether of polyhydric aliphatic alcohol, and the like)], and thiokol-modified epoxy resin.

In the present invention, one kind or two or more kinds thereof may be used.

The above-mentioned silicone resins are not particularly limited. Examples of the above-mentioned silicone resins include the conventionally known various silicone resins such as silicone resin which is generally used as a resin component in a silane-based primer, for example, an organopolysiloxane resin containing a hydroxyl group or an alkoxy group which are attached to a silicon atom and corresponding to the following formula:

R¹ₘSiO_{(4-m-n)/2}(OR²)ₙ

[wherein R¹ represents a C1-C6 alkyl group, R² represents a hydrogen atom or a C1-C6 alkyl group, m represents a value of from 0.8 to 1.8 and n represents a value selected so that the number of the hydroxyl groups or the alkoxy groups which are attached to the silicon atom in one molecule becomes more than monovalent]

The monovalent hydrocarbon groups having 1 to 6 carbon atoms represented as R¹ are not particularly limited. Examples of the monovalent hydrocarbon groups include a Cl-6 alkyl group such as methyl group, an ethyl group and a propyl group, a C2-6 alkenyl group such as a vinyl group and an allyl group. The hydrocarbon groups having 1 to 6 carbon atoms represented as R² are not particularly limited. Examples of hydrocarbon groups having 1 to 6 carbon atoms include a methyl group, an ethyl group, a propyl group, a butyl group, a pentyl group, a hexyl group and the like.

In the present invention, one kind or two or more kinds thereof may be used.

The primer composition of the present invention preferably comprises a yellowing-resistant resin as a binder resin. A problem of the appearance caused by yellowing of a resin can be prevented by using a yellowing-resistant resin as a binder resin.

In the present invention, “a yellowing-resistant resin” means a resin which is clear and colorless and hardly changes in color even if an external energy such as heat and ultraviolet is applied.

The above-mentioned yellowing-resistant resins include an aliphatic polyisocyanate, an aliphatic urethane resin, an alicyclic polyisocyanate, an alicyclic urethane resin, an olefine resin, an acrylic resin, a polyester resin, silicone resin and the like.

Examples of the above-mentioned aliphatic polyisocyanates include tetramethylene diisocyanate, pentamethylene diisocyanate, hexamethylene diisocyanate, ricin diisocyanate and derivatives thereof.

Examples of the aliphatic urethane resins include a compound of the above-mentioned aliphatic polyisocyanate and the above-mentioned polyol.

Examples of the alicyclic polyisocyanates include isophorone diisocyanate, cyclohexyl diisocyanate, dicyclohexylmethane diisocyanate, norbornane diisocyanate.

Examples of the alicyclic urethane resins include a compound of the above-mentioned alicyclic polyisocyanate and the above-mentioned polyol.

Examples of the olefine resin, the acrylic resin, the polyester resin and the silicone resin include those mentioned above and the like.

In addition to the binder resin (A), the primer composition of the present invention comprises one or more pigments (B) selected from the group consisting of curcumin pigment, monascus pigment, chlorophyll, capsicum pigment, marigold pigment and caramel pigment as a color-fading pigment.

“Curcumin pigment” used as the pigment (B) is a yellow pigment (under alkaline conditions, red-brown) which is contained by a rootstock of the zingiberaceous plant turmeric (Curcuma longa L.). Examples of “curcumin pigment” include 1,7-bis(4-hydroxy-3-methoxyphenyl)-1,6-heptadiene 3,5-dione, demethoxycurcumin, bis-demethoxycurcumin and the like. These curcumin pigments can be used alone or as a mixture of two or more kinds thereof.

Curcumin pigment exists in two tautomeric forms, keto and enol. The both forms can be used without particular distinction in the present invention.

Curcumin pigment can be produced, for example, by organic solvent extraction from turmeric as a raw material.

Curcumin pigment is commercially available under a trade name “CURCUMIN W” (Hodogaya Chemical Company Limited), “WINNER YELLOW CONC” (Kiriya Chemical Company Limited) and the like.

“Monascus pigment” used as the pigment (B) is a yellow or red pigment which is contained by Monascus pilosus. Examples of “monascus pigment” include rubropunctatin, rubropunctamine, monascorubrin monascorubrin, monascorubramin, monascin, ankaflavin and the like. These monascus pigments can be used alone or as a mixture of two or more kinds thereof.

Monascus pigment can be produced, for example, by hydrous organic solvent extraction from Monascus pilosus.

Monascus pigment is commercially available under a trade name “MONAS RED LAR” (Hodogaya Chemical Company Limited), “MONASCO RED PG” (Kiriya Chemical Company Limited) and the like.

“Chlorophyll” used as the pigment (B) is a green pigment (plants, etc) or a red pigment (purple bacterium, etc) which is contained by a plant, cyanobacteria, photosynthesis or the like. Examples of “chlorophyll” include various types of chlorophyll (chlorophyll a, b, c1, c2, d, etc.), various types of bacterio-chlorophyll (chlorophyll a, b, c, d, e, f, g, etc.) and the like. The above-mentioned chlorophylls can be used alone or as a mixture of two or more kinds thereof.

Chlorophyll can be produced, for example, by organic solvent extraction from a plant, cyanobacteria, photosynthesis or the like.

Chlorophyll is commercially available under a trade name “NEOGREEN O” (Hodogaya Chemical Company Limited) and the like.

“Capsicum pigment” used as the pigment (B) is an orange-yellow pigment or a red-orange pigment which is contained by a fruit of the solanaceous plant capsicum (which is also referred to as paprika) (capsicum annuum). Examples of “capsicum pigment” include capsanthin and the like. The above-mentioned capsicum pigments can be used alone or as a mixture of two or more kinds thereof.

Capsicum pigment can be produced, for example, by organic solvent extraction from a fruit of capsicum (paprika).

Capsicum pigment is commercially available under a trade name “CAPROCHIN L” (Hodogaya Chemical Company, Limited) and the like.

“Marigold pigment” used as the pigment (B) is a yellow or orange pigment which is contained by a flower of marigold. Examples of “marigold pigment” include lutein, zeaxanthin and the like. The above-mentioned marigold pigments can be used alone or as a mixture of two or more kinds thereof.

Marigold pigment can be produced, for example, by organic solvent extraction from a flower of marigold.

Marigold pigment is commercially available under a trade name “MARIGOLD O” (Hodogaya Chemical Company Limited) and the like.

“Caramel pigment” used as the pigment (B) is a brown pigment which is obtained by heat-treating a starch hydrolysate, an edible carbohydrate of molasses or sugars. The above-mentioned caramel pigments can be used alone or as a mixture of two or more kinds thereof.

Caramel pigment can be produced, for example, by heat-treating (for example, from 170° C. to 200° C.) a starch hydrolysate, glucose, sugar or the like.

Caramel pigment is commercially available under a trade name “OS CARAMEL PM” (Hodogaya Chemical Company Limited) and the like.

A primer composition of the present invention which contains the pigment (B) exhibits a color according to the pigment (for example, in the case of curcumin pigment, yellow (in the case of an alkaline composition, red-brown)). Accordingly, the coating quality can be visually inspected. On the other hand, the pigment (B) fades on exposure to the light (in particular, ultra violet) and becomes colorless. For example, in the case of curcumin pigment, a cyclization reaction proceeds at the olefinic double bond part in the structure and the pigment varies from yellow to colorless. Accordingly, a primer composition of the present invention sufficiently fades in a short time when it is applied to an adherend and subsequently exposed to the light. Accordingly, a problem in the appearance is not caused when a primer composition of the present invention overflows or adheres to an adherend surface.

The pigment (B) is soluble in an organic solvent such as aromatic compound such as toluen, alcohol such as ethanol, isopropyl alcohol and propylene glycol, ester such as ethyl acetate and butyl acetate as well as ketone such as acetone. Accordingly, the pigment (B) can also be contained by a solvent based-primer composition. In this case, the pigment (B) can be selected depending on a solvent used.

The amount of the pigment (B) in the primer composition of the present invention is, but not particularly limited to, preferably 0.001 to 10 wt. %, more preferably 0.01 to 5 wt. % based on the whole amount of the composition from the viewpoint of the fading property and that the coating quality can be easily inspected.

When the pigment (B) is used in an amount of less than 0.001 wt. %, it is difficult to inspect the coating quality. When the pigment (B) is used in an amount of more than 10 wt. %, there is fear that it takes a long time to fade and that the pigment (B) does not sufficiently fade on the north face.

In addition to the components (A) and (B), the primer composition of the present invention may optionally contain a solvent (C), a adherence agent (D) and/or a catalyst (E) as a component known as an additive of a primer composition.

Examples of the solvent (C) include an aromatic compound such as toluen and xylene, an alcohol such as methanol, ethanol, isopropyl alcohol and butanol, ketone such as acetone and methyl ethyl ketone, ester such as ethyl acetate and butyl acetate, ether such as butyl cellosolve, ligroin, tetrahydrofuran, n-hexane, heptane and the like. These solvents can be used alone or as a mixture of two or more kinds thereof.

The amount of the solvent in the primer composition of the present invention is, but not particularly limited to, preferably 40 to 99 wt. %, more preferably 50 to 99 wt. % based on the whole amount of the composition from the viewpoint of the workability and the film-forming rate.

Examples of the above-mentioned adherence agent (D) include a silane coupling agent such as gamma-(alpha-aminoethyl)aminopropyl trimethoxysilane, aminopropyl trimethoxysilane, gamma-phenylaminopropyl trimethoxysilane, bis(trimethoxysilylpropyl)amine, N-(beta-aminoethyl)-gamma-aminopropyl trimethoxysilane, ureidopropyltriethoxysilane, N-(n-butyl)-gamma-aminopropyltrimethoxysilane, N-(cyclohexyl)-gamma-aminopropyltrimethoxysilane, gamma-mercaptopropyltrimethoxysilane and N-methylaminopropyltrimethoxysilane, a silicate compound (for example, tetramethoxysilane, tetraethoxysilane, tetrapropoxysilane; and silicates such as ethylpolysilicate, propylpolysilicate, butylpolysilicate, methylcellosolve orthosilicate, n-propylorthosilicate and tetramethylsilicate), a siloxane compound such as dodecamethylpentasiloxane, an organopolysiloxane resin and the like.

These adherence agents can be used alone or as a mixture of two or more kinds thereof.

The amount of the adherence agent in the primer composition of the present invention is, but not particularly limited to, preferably 0.5 to 10 wt. %, more preferably 1 to 5 wt. % based on the whole amount of the composition from the viewpoint of the adhesiveness.

Examples of the above-mentioned catalyst (E) include tin-based catalysts such as dioctylacid tin, dibutyltin dilaurate, dibutyltin bisacetylacetate, dibutyltin diacetate, dibutyltin diethylhexanoate, dibutyltin dioctoate, dibutyltin oxide and dioctyltin oxide, titanium-based catalysts such as tetraisopropyl titanate, tetra n-butyl titanate and partial hydrolysis condensates thereof, titanium diisopropylbisacetylacetate and titanium diisopropylbisethylethylacetoacetate and the like.

The amount of the catalyst in the primer composition of the present invention is, but not particularly limited to, preferably 0.01 to 10 wt. %, more preferably 0.01 to 5 wt. % based on the whole amount of the composition from the viewpoint of the film-forming rate.

The primer composition of the present invention can contain the proper amount of an inorganic filler which is usually used, such as fumed silica and colloidal silica, a color-fading colorant other than the pigment (B), such as synthetic pigment described in JP-A 2002-285098 other than the above-mentioned pigment (B).

The primer composition of the present invention can be visually inspected for the coating quality and can sufficiently fade on exposure to the light. For example, the coating quality can be visually inspected for hours or days when a primer composition containing 0.01 to 5 wt. %, based on the whole amount of the composition, of curcumin pigment is applied in a thickness of 10 to 100 μm, and subsequently, exposed out of door during the day. After that, however, it is difficult to visually inspect the coating quality since the color of the primer composition fades.

Thus, the primer composition of the present invention can be used, for example, as a primer composition for various sealants such as sealant for construction.

### EXAMPLES

### Examples 1-9

Components of each of a solvent, a binder resin, an adherence agent, a catalyst and a color-fading pigment were mixed in a quantitative ratio (parts by weight: the quantitative ratio encompasses the amount of a solvent if the component contains a solvent) shown in Table 1. Subsequently, a primer composition was obtained.

### Comparative Examples 1 and 2

Components of each of a solvent, a binder resin, an adherence agent and a catalyst were mixed in a quantitative ratio (parts by weight: the quantitative ratio encompasses the amount of a solvent if the component contains a solvent) shown in Table 1. Subsequently, a primer composition was obtained.

### [Performance Test]

### [Visibility of the Coating Quality]

Each primer composition was applied to the bonder face of a wood-based siding board (MOENEXELARD; manufactured by NICHIHA Company, Limited) in an amount of 370 ml/m², allowed to stand at 20° C. for 1 hour, and then, visually inspected. The coating quality was evaluated as follows:

Good: The coating quality of a primer can be easily inspected.
Poor: The coating quality of a primer is hardly inspected.

### [Color-Fading]

Each primer composition was applied to the white painted surface in an amount of 270 ml/m². The coating of a primer is vertically exposed on the south face out of doors for 2 days, and then, visually inspected. The color-fading was evaluated as follows:

Good: The color tone of a primer is not visible.
Poor: The color tone of a primer is visible.

TABLE1

| | | Example | Example | Example | Example | Example | Example | Example |
|---|---|---|---|---|---|---|---|---|
| | | 1 | 2 | 3 | 4 | 5 | 6 | 7 |
| Solvent | ethyl acetate | 52 | 52 | 52 | 52 | 52 | 52 | 52 |
| | butyl acetate | 20 | 20 | 20 | 20 | 20 | 20 | 20 |
| Binder | aliphatic | 22 | 22 | 22 | 22 | 22 | | |
| resin | polyisocyanate¹⁾ | | | | | | | |
| | acrylic resin²⁾ | | | | | | 22 | 22 |
| Adherence | mercaptosilane³⁾ | 3 | 3 | 3 | 3 | 3 | 3 | 3 |
| agent | | | | | | | | |
| Color- | curcumin | 1 | 10 | 20 | | | | |
| fading | pigment⁴⁾ | | | | | | | |
| pigment | monascus | | | | 1 | | | |
| | pigment⁵⁾ | | | | | | | |
| | chlorophyll⁶⁾ | | | | | 1 | | |
| | capsicum | | | | | | 1 | 10 |
| | pigment⁷⁾ | | | | | | | |
| | marigold | | | | | | | |
| | pigment⁸⁾ | | | | | | | |
| | caramel pigment⁹⁾ | | | | | | | |
| Catalyst | tin compound¹⁰⁾ | 0.5 | 0.5 | 0.5 | 0.5 | 0.5 | 0.5 | 0.5 |
| Total | | 98.5 | 107.5 | 117.5 | 98.5 | 98.5 | 98.5 | 107.5 |

| | | | | | | | |
|---|---|---|---|---|---|---|---|
| Visibility of the coating | Good | Good | Good | Good | Good | Good | Good |
| quality | | | | | | | |
| Fading | Good | Good | Good | Good | Good | Good | Good |

| | | Example | Example | Comparative | Comparative |
|---|---|---|---|---|---|
| | | 8 | 9 | Example 1 | Example 2 |
| Solvent | ethyl acetate | 52 | 52 | 52 | 52 |
| | butyl acetate | 20 | 20 | 20 | 20 |
| Binder | aliphatic | | | 22 | |
| resin | polyisocyanate¹⁾ | | | | |
| | acrylic resin²⁾ | 22 | 22 | | 22 |
| Adherence | mercaptosilane³⁾ | 3 | 3 | 3 | 3 |
| agent | | | | | |
| Color- | curcumin | | | | |
| fading | pigment⁴⁾ | | | | |
| pigment | monascus | | | | |
| | pigment⁵⁾ | | | | |
| | chlorophyll⁶⁾ | | | | |
| | capsicum | | | | |
| | pigment⁷⁾ | | | | |
| | marigold | 1 | | | |
| | pigment⁸⁾ | | | | |
| | caramel pigment⁹⁾ | | 3 | | |
| Catalyst | tin compound¹⁰⁾ | 0.5 | 0.5 | 0.5 | 0.5 |
| Total | | 98.5 | 100.5 | 97.5 | 97.5 |

| | | | | |
|---|---|---|---|---|
| Visibility of the coating | Good | Good | Poor | Poor |
| quality | | | | |
| Fading | Good | Good | — | — |

Note
¹⁾Aliphatic polyisocyanate: a solution of 70 wt. % isophorone diisocyanate in solvent naphtha
²⁾Acrylic resin: Acrit1403EA (40 wt. % of acrylic resin, 60 wt. % of ethyl acetate, Taisei Fine Chemical Company, limited)
³⁾Mercaptosilane: KBM803 (3-mercaptopropyltrimethoxysilane, Shin-Etsu Chemical Company, limited)
⁴⁾Curcumin pigment: CURCUMIN W (a solution of 5 wt. % curcumin in propylene glycol, Hodogaya Chemical Company, Limited)
⁵⁾Monascus pigment: MONASRED LAR (a solution of 50 wt. % monascus pigment in ethyl alcohol, Hodogaya Chemical Company, Limited)
⁶⁾Chlorophyll: NEOGREEN O (a solution of 50 wt. % chlorophyll in vegetable oil, Hodogaya Chemical Company Limited)
⁷⁾Capsicum pigment: CAPROTHIN L (a solution of 98 wt. % capsicum pigment in mixed tocopherol, Hodogaya Chemical Company, Limited)
⁸⁾Marigold pigment: MARIGOLD O (a solution of 7 wt. % marigold pigment in vegetable oil, Hodogaya Chemical Company Limited)
⁹⁾Caramel pigment: OS CARAMEL PM (a solution of 40 wt. % caramel in glycerin ester, Hodogaya Chemical Company Limited)
¹⁰⁾Tin compound: NEOSTAN U-8 (dibutyltin dioctoate, Nitto Kasei Company, Limited)

From the result of Table 1, in the primer composition containing the specific pigment (Examples 1-9), it was confirmed that the coating quality of a primer could be visually inspected and that the color tone of a primer was disappeared after the coating of a primer was vertically exposed on the south face out of doors for 2 days. On the other hand, in the primer composition containing no pigment (Comparative Examples 1 and 2), it was confirmed that the visual inspection of the coating quality of a primer was difficult.

1. A primer composition for sealant, comprising
(A) a binder resin, and
(B) one or more pigments selected from the group consisting of curcumin pigment, monascus pigment, chlorophyll, capsicum pigment, marigold pigment and caramel pigment.

2. The primer composition according to claim 1, comprising 0.001 to 10 wt. %, based on the whole amount of the composition, of the pigment (B).

3. The primer composition according to claim 1, wherein the pigment (B) comprises curcumin pigment.

4. The primer composition according to claim 1, wherein the pigment (B) comprises monascus pigment.

5. The primer composition according to claim 1, wherein the pigment (B) comprises chlorophyll.

6. The primer composition according to claim 1, wherein the binder resin (A) comprises a yellowing-resistant resin.

7. The primer composition according to claim 6, wherein the yellowing-resistant resin is selected from the group consisting of an aliphatic polyisocyanate, an aliphatic urethane resin, a cycloaliphatic polyisocyanate, a cycloaliphatic urethane resin, an olefin resin, an acrylate resin, a polyester resin and a silicone resin.

8. The primer composition according to claim 2, wherein the pigment (B) comprises curcumin pigment.

9. The primer composition according to claim 2, wherein the pigment (B) comprises monascus pigment.

10. The primer composition according to claim 2, wherein the pigment (B) comprises chlorophyll.

11. The primer composition according to claim 2, wherein the binder resin (A) comprises a yellowing-resistant resin.

12. The primer composition according to claim 3, wherein the binder resin (A) comprises a yellowing-resistant resin.

13. The primer composition according to claim 4, wherein the binder resin (A) comprises a yellowing-resistant resin.

14. The primer composition according to claim 5, wherein the binder resin (A) comprises a yellowing-resistant resin.
